(19) United States
(12) Patent Application Publication
(10) Pub. No.: US 2020/0339479 A1
(43) Pub. Date: Oct. 29, 2020

(54) REFRACTORY PLATE FOR A SLIDE GATE VALVE, USE OF A FUSED RAW MATERIAL AS A MATERIAL IN SUCH A PLATE AND A MELTING VESSEL COMPRISING SUCH A PLATE

(71) Applicant: Refractory Intellectual Property GmbH & Co. KG, Wien (AT)

(72) Inventors: Renaud Grasset-Bourdel, Trofaiach (AT); Martin Wiesel, Trofaiach (AT); Vincent Meurillon, Dourda (FR); Harald Taferner, Judenburg (AT)

(21) Appl. No.: 16/761,157

(22) PCT Filed: Jul. 17, 2018
(86) PCT No.: PCT/EP2018/069413

§ 371 Date: May 1, 2020

(30) Foreign Application Priority Data
Nov. 8, 2017 (EP) 17200546.4

(51) Int. Cl. C04B 35/109; B22D 41/32

(52) U.S. Cl. CPC C04B 35/109; B22D 41/32; C04B 2235/3217; C04B 2235/3248; C04B 2235/9676; C04B 2235/3826; C04B 2235/3895; C04B 2235/428; C04B 2235/9607; C04B 2235/425

(57) ABSTRACT

The invention relates to a refractory plate for a sliding shutter for regulating a flow rate of liquid steel, to the use of a melt raw material as material in a plate of this kind and to a melt vessel for receiving liquid steel which has a plate of this kind for regulating a flow rate of liquid steel from the melt vessel.

The invention relates to a refractory plate for a slide gate valve for controlling a flow rate of liquid steel, the use of a fused raw material as a material in such a plate and a melting vessel for receiving liquid steel, comprising such a plate for controlling a flow rate of liquid steel from the melting vessel.

Refractory plates in a slide gate valve serve to control a flow rate of liquid steel from a melting vessel for receiving liquid steel or molten steel, respectively. Such a vessel may in particular be a ladle or tundish in a continuous casting plant for casting steel. In order to pour a steel melt in such a ladle into an aggregate downstream of the ladle in terms of production, such ladles have an opening which is arranged in particular at the bottom of such ladles. Refractory plates in a slide gate valve are used to control the flow of molten steel through such an opening. Such plates have a passage opening through which liquid steel can be passed.

A slide gate valve is located in the area of the opening of the melting vessel. Such a slide gate valve comprises several refractory plates to control the flow of molten steel from the opening. To this extent, such a slide gate valve regularly comprises one or two fixed refractory plates, each of which has a passage opening which is aligned with the opening of the melting vessel. Another refractory plate, the so-called “slide gate plate”, lies flat against the fixed plates and is arranged so as to be slidable relative to these fixed plates. The slide gate plate can be slid into a first position in which the passage opening of the slide gate plate is aligned with the passage openings of the fixed plates so that the molten steel can flow out of the melting vessel through the opening of the melting vessel and the aligned passage openings of the plates. Furthermore, the slide gate plate can be moved to a second position in which the passage openings of the fixed plates are closed by the slide gate plate. A hydraulic or electric drive can be provided to move the slide gate plate.

A fixed refractory plate, which is located above a slide gate plate, is also called “top plate” or “bottom plate”. “Plate” is herein referred to as both an “top plate” and a “slide gate plate”.

Plates in a slide gate valve consist of refractory ceramic materials.

During the passage of liquid steel through the passage opening of the plate, it is exposed to extreme temperature fluctuations, extreme temperatures and extreme mechanical or corrosive attack. The extreme temperature fluctuations occur not only during the opening and closing of the gate valve but also during the passage of the molten steel through the opening due to temperature gradients within the plate.

In order to withstand these extreme loads, the refractory ceramic material of the plate must not only have a high refractoriness but also a high thermal shock resistance and a high corrosion resistance.

However, as is well known, there is the dilemma that in the case of the refractory ceramic materials known from the state of the art for the production of refractory plates, an improvement of one of these resistances results in a deterioration of the other resistance. In this respect, for example, in the case of the refractory materials known from the state of the art for the production of plates, an improvement in corrosion resistance may result in a deterioration in thermal shock resistance.

Against this background, an object of the invention is providing a refractory plate for a slide gate valve for controlling a flow rate of liquid steel, which has both a high thermal shock resistance and a high corrosion resistance. In particular, an object of the present invention is providing such a plate for a slide gate valve of a ladle or tundish in a continuous casting plant for casting steel, which has a high thermal shock resistance and a high corrosion resistance, in particular a higher thermal shock resistance and corrosion resistance than the refractory ceramic materials for plates known from the state of the art.

A further object of the invention is providing a melting vessel for receiving liquid steel, the melting vessel having at least one such plate for controlling a flow rate of liquid steel from the melting vessel.

For solving these objects, according to the invention, a refractory plate for a slide gate valve for controlling a flow rate of liquid steel is provided, which comprises a fused raw material, wherein this fused raw material comprises the following elements each in a proportion in the range of the following mass fractions:

aluminum: 46-55% by mass;

oxygen: 42-49% by mass;

carbon: 0.1-3% by mass;

silicon: 0.1-4% by mass.

Surprisingly, it turned out according to the invention that a refractory plate for a slide gate valve can be provided which solves the above objects if it comprises a refractory material in the form of the above-mentioned fused raw material with the indicated elements in the indicated mass fractions. In particular, it turned out in accordance with the invention that a plate which has such a fused raw material a plate can be provided which simultaneously has both a high thermal shock resistance and a high corrosion resistance.

The term “plate” is used herein to describe a top plate, bottom plate or slide gate plate for a slide gate valve, both unfired (in particular resin-bonded) and fired (in particular carbon-bonded).

The “fused raw material” of the plate according to the invention, also referred to herein as “fused raw material according to the invention”, is a raw material obtained from a cooled, solidified melt. Fused raw materials according to the state of the art are known, for example, in the form of fused corundum or fused magnesia.

The inventors assume that the good thermal shock resistance and good corrosion resistance of the plate according to the invention are due to the phases in the fused raw material according to the invention which are formed in the fused raw material at the proportions of the above elements according to the invention.

The mass fractions of the elements in the fused raw material according to the invention disclosed herein are each related to the total mass of the fused raw material according to the invention in the plate according to the invention.

The mass fraction of the elements in the fused raw material according to the invention is determined according to ASTM E 1508-98 (Reapproved 2003).

The mass fraction of aluminum in the fused raw material according to the invention is in the range of 46 to 55% by mass. In accordance with the invention, it was found that the refractory properties of the plate according to the invention, in particular its thermal shock resistance and corrosion resistance, are increasingly improved to the extent that the proportion of aluminum in the fused raw material according to the invention increasingly approaches a proportion of 49.6% by mass. In this respect, more preferably, a proportion of aluminum in the fused raw material according to the invention in the range from 47 to 53% by mass and even more preferably in the range of 48 to 52% by mass may be provided.

The mass proportion of oxygen in the fused raw material according to the invention is in the range of 42 to 49% by mass. In accordance with the invention, it was found that the refractory properties of the plate according to the invention, in particular its thermal shock resistance and corrosion resistance, are increasingly improved to the extent that the proportion of oxygen in the fused raw material according to the invention increasingly approaches a proportion of 45.8% by mass. In this respect, more preferably, a proportion of oxygen in the fused raw material according to the invention in the range of 43 to 49% by mass and even more preferably in the range of 44 to 49% by mass may be provided.

The mass proportion of carbon in the fused raw material according to the invention is in the range of 0.1 to 3% by mass. In accordance with the invention, it was found that the refractory properties of the plate according to the invention, in particular its thermal shock resistance and corrosion resistance, are increasingly improved to the extent that the proportion of carbon in the fused raw material according to the invention increasingly approaches a proportion of 0.5% by mass. In this respect, more preferably, a proportion of carbon in the fused raw material according to the invention in the range of 0.2 to 2.0% by mass and even more preferably in the range of 0.3 to 1.0% by mass may be provided

The mass proportion of silicon in the fused raw material according to the invention is in the range of 0.1 to 4% by mass. In accordance with the invention, it was found that the refractory properties of the plate according to the invention, in particular its thermal shock resistance and corrosion resistance, are increasingly improved to the extent that the proportion of silicon in the fused raw material according to the invention increasingly approaches a proportion of 1.1% by mass. In this respect, more preferably, a proportion of silicon in the fused raw material according to the invention in the range of 0.5 to 3% by mass and even more preferably in the range of 0.5 to 2% by mass may be provided.

In accordance with the invention, it was further determined that the refractory properties of the plate according to the invention, in particular its thermal shock resistance and corrosion resistance, can be further improved to the extent that the fused raw material according to the invention also contains nitrogen, preferably in a mass fraction in the range of 0.01 to 0.3% by mass.

According to the invention, it was determined that the refractory properties of the plate according to the invention can deteriorate if the fused raw material according to the invention comprises, in addition to the elements aluminum, silicon, oxygen, carbon and nitrogen, in particular in the aforementioned proportions, proportions of further elements. According to a preferred embodiment, it is therefore provided that the fused raw material according to the invention for the plate according to the invention comprises the elements aluminum, oxygen, carbon, silicon and nitrogen in a total proportion of at least 98% by mass, even more preferably in a total proportion of at least 99% by mass, in each case relative to the total mass of the fused raw material.

Correspondingly, it may be provided that the fused raw material according to the invention contains, in addition to the elements aluminum, oxygen, carbon, silicon and nitrogen, further elements in a total proportion of less than 2% by mass, even more preferably in a total proportion of less than 1% by mass, in each case relative to the total mass of the fused raw material according to the invention.

According to a preferred embodiment, it is intended that the fused raw material according to the invention comprises the element silicon wholly or partially in the form of SiC (silicon carbide). Preferably, it is provided that the fused raw material according to the invention comprises silicon predominantly in the form of SiC. According to one embodiment, it is provided that the fused raw material according to the invention has an SiC content in the range of 0.1 to 3% by mass.

Surprisingly, it was found within the scope of the invention that the plate according to the invention has excellent thermal shock resistance and corrosion resistance, in particular if the fused raw material according to the invention in the plate according to the invention comprises the phase Al₂₈C₆N₆O₂₁. According to a preferred embodiment, it is provided that the fused raw material according to the invention of the plate according to the invention comprises the phase Al₂₈C₆N₆O₂₁ in a proportion in the range of 0.05 to 10% by mass.

According to a preferred embodiment, it is provided that the fused raw material according to the invention comprises the phases SiC and Al₂₈C₆N₆O₂₁ in a total mass in the range of 0.15 to 11.5% by mass, even more preferably in a total mass in the range of 0.5 to 11.5% by mass.

Preferably, according to the invention, the fused raw material according to the invention comprises the phase corundum (Al₂O₃), preferably as the main phase, particularly preferably in a proportion of at least 50% by mass, relative to the total mass of the fused raw material according to the invention. According to a preferred embodiment, the fused raw material according to the invention comprises the phase corundum in a proportion in the range from 80 to 98% by mass, even more preferably in a proportion in the range from 85 to 98% by mass.

As further phases, the fused raw material according to the invention can have at least one of the following phases: metallic silicon, metallic aluminum or Al₄O₄C, preferably in a total mass of less than 3%by mass.

The above data on the mass fraction of SiC, Al₂₈C₆N₆O₂₁, corundum, metallic phases as well as Al₄O₄C in the fused raw material according to the invention are each based on the total mass of the fused raw material according to the invention.

According to the invention, it was found that the grain size of the fused raw material according to the invention has an influence on the thermal shock resistance and corrosion resistance of the plate according to the invention. In this respect, it was found that the thermal shock resistance and corrosion resistance of the plate according to the invention is particularly high if the fused raw material according to the invention comprises grains with a coarse grain fraction, i.e. grains with a large average grain size. In this respect, according to a preferred embodiment, the fused raw material according to the invention comprises grains with an average grain size of more than 0.5 mm. It is particularly preferably provided that at least 45% by mass of the fused raw material according to the invention is present in the plate according to the invention in an average grain size of at least 0.5 mm. According to a continuation of this embodiment, it is provided that at least 45% of the fused raw material according to the invention is present in an average grain size in the range of 0.5 to 5 mm and particularly preferably in an average grain size in the range of 0.5 to 3 mm. According to one embodiment, it is provided that at most 55% by mass of the fused raw material according to the invention is present in an average grain size below 0.5 mm. The aforementioned data on the grain size in % by mass are in each case related to the total mass of the fused raw material according to the invention. The grain size is determined according to DIN EN 933-2:1996-01.

For the production of the fused raw material according to the invention of the plate according to the invention, first of all a batch of raw materials is provided, this batch is melted to a melt and the melt is then cooled down. The cooled, solidified melt then represents a fused raw material according to the invention, as it is used in the plate according to the invention. In order to provide the fused raw material as a raw material for the production of the plate according to the invention, the cooled, solidified melt can be processed in pieces, i.e. it can be crushed to the desired grain size, for example, in particular to a grain size as specified above.

In order to provide a fused raw material according to the invention with the above proportions of aluminum, silicon and oxygen, the batch provided for the production of the fused raw material according to the invention comprises on the one hand preferably at least one raw material based on alumina (Al₂O₃) and on the other hand at least one of the following raw materials: a raw material based on silicon dioxide (SiO₂) or a raw material based on silicon dioxide and alumina. Particularly preferably, the batch provided for the production of the fused raw material according to the invention comprises on the one hand a raw material based on alumina and on the other hand at least one raw material based on silicon dioxide and alumina.

A raw material based on alumina can preferably be present in the form of at least one of the following raw materials: calcined alumina, fused alumina or sintered alumina. A raw material based on alumina is particularly preferred in the form of calcined alumina.

A raw material based on silicon dioxide and alumina can preferably be present in the form of at least one of the following raw materials: kaolin, metakaolin or fireclay.

A raw material based on silica can preferably be in the form of microsilica.

In order to provide the proportions of carbon in the fused raw material according to the invention, the batch provided for the production of the fused raw material according to the invention preferably comprises at least one carbon carrier, i.e. a raw material which is a carrier of free carbon. Graphite is preferably present as the carbon carrier.

In order to provide the proportions of nitrogen in the fused raw material according to the invention, it may preferably be provided that the batch is melted in an atmosphere comprising nitrogen, for example from the air. The nitrogen is thus incorporated into the fused raw material from the surrounding atmosphere during melting.

The raw materials of the batch for producing the fused raw material according to the invention are combined in such a way that the fused raw material, after melting and cooling of the batch, has the composition described herein. In this respect, it was determined in accordance with the invention that parts of the carbon (in particular in the form of CO₂) as well as parts of the silicon dioxide of the batch pass into the gas phase during melting, volatilize accordingly and are therefore no longer available for the fused raw material. For this reason, the batch from which the fused raw material according to the invention is melted regularly contains higher proportions of silicon and carbon than the fused raw material according to the invention.

The batch provided for the production of the fused raw material according to the invention may preferably comprise the following proportions of a raw material based on alumina, a raw material based on alumina and silicon dioxide, and a carbon carrier:

raw material based on alumina: 87-95% by mass, more preferably 87-91% by mass;

raw material based on alumina and silica: 1-12% by mass, more preferably 7-9% by mass;

carbon carrier: 1-4% by mass, more preferably 2-4% by mass.

The figures given in % by mass are in each case based on the total mass of the batch.

Preferably, it is provided that the batch to be melted comprises the above-mentioned raw materials in a total proportion of at least 99%, even more preferably 100%, in relation to the total mass of the batch to be melted.

The melting of the batch can be performed in accordance with the technologies known from the state of the art for melting batch for the production of refractory fused raw materials, in particular preferably in an electric arc furnace. Preferably, melting takes place under a reducing atmosphere. After melting the batch, the melt is cooled to room temperature, whereby the melt solidifies and a fused raw material according to the invention is obtained. The melt can then be comminuted as described above.

Basically, it was found according to the invention that the thermal shock resistance and corrosion resistance of a plate according to the invention can already be improved by the fused raw material according to the invention if the plate comprises the fused raw material in very small proportions, for example in a proportion of at least 1% by mass. In accordance with the invention, it was found that a considerable improvement in the thermal shock resistance and corrosion resistance of the plate is achieved if the plate comprises the fused raw material in a proportion of at least 3% by mass. Furthermore, it was determined according to the invention that the thermal shock resistance and corrosion resistance of a plate according to the invention can hardly be further improved or even deteriorate again (the brittleness of the plate can increase) if the proportion of the fused raw material according to the invention in the plate is very high, especially as from a proportion of more than 70% by mass. In accordance with the invention, it was found that a plate according to the invention has the best values for thermal shock resistance and corrosion resistance if it contains the fused raw material according to the invention in a proportion of about 50% by mass. In this respect, according to a preferred embodiment, it is provided that the plate according to the invention comprises the fused raw material according to the invention in a proportion in the range from 3 to 70% by mass, even more preferably in a proportion in the range from 20 to 60% by mass, even more preferably in a proportion in the range from 30 to 60% by mass and particularly preferably in a proportion of 50% by mass, in each case relative to the total mass of the plate.

The plate according to the invention is in the form of an unfired or fired refractory product comprising the fused raw material according to the invention.

Insofar as the plate according to the invention is available unfired, it is preferably available as a green body, in particular as a resin-bonded (in particular tempered) unfired plate comprising the fused raw material according to the invention.

Insofar as the plate according to the invention is fired, it is preferably present as a carbon-bonded plate comprising the fused raw material according to the invention.

In particular, the plate according to the invention is preferably in the form of a refractory product based on alumina and carbon (i.e. as a so-called refractory “alumina-carbon product”).

Such plates in the form of an alumina-carbon product based on alumina and carbon are known from the state of the art. Such state of the art plates are based on alumina raw materials, in particular fused alumina, and possibly also other raw materials, in particular in the form of zirconium oxide, as well as any additives (e.g. elasticisers in the form of zirconium mullite) and antioxidants (e.g. metals or metal carbides).

When such plates are fired, the carbon components of the plate form a carbon bond, so that the fired plate is a carbon-bonded refractory product.

The plate according to the invention may be constructed in accordance with the state of the art in the form of alumina-carbon products, with the difference that the alumina raw materials are wholly or partly in the form of the fused raw material according to the invention. For the production of the plate according to the invention, the technologies known from the state of the art for the production of such plates in the form of alumina-carbon products may be used.

In addition to the fused raw material according to the invention, the plate according to the invention comprises one or more further refractory raw materials, in particular one or more further refractory raw materials having refractory plates for slide gate valves known from the state of the art. In particular, the plate according to the invention may comprise, in addition to the fused raw material according to the invention described herein, one or more refractory raw materials based on at least one of the following raw materials: alumina, zirconia or zircon mullite.

According to a preferred embodiment, the plate according to the invention has —in addition to the fused raw material according to the invention—one or more further raw materials based on at least one of the raw materials alumina, zirconia or zircon mullite in a total proportion of 30 to 95% by mass, even more preferably in a total proportion in the range of 40 to 80% by mass, even more preferably in a total proportion in the range of 40 to 70% by mass and even more preferably in a total proportion of 40 to 50% by mass, in each case relative to the total mass of the plate.

Particularly preferably, the plate according to the invention comprises, in addition to the melting raw material described herein and one or more raw materials based on alumina, zirconia or zircon mullite, the further raw material carbon (in particular in the form of graphite), preferably in a proportion in the range from 1 to 10% by mass, particularly preferably in a proportion in the range from 2 to 9% by mass, based in each case on the total mass of the plate.

For the production of the plate according to the invention, the fused raw material according to the invention and the further raw materials for the production of the plate can be mixed together and processed according to the state of the art to form plates, in particular in the form of carbon-bonded plates.

In this respect, the fused raw material according to the invention and the other raw materials for producing a carbon-bonded pate can be mixed together first, in particular by adding a coking binder. In this respect, the coking binders known from the state of the art can be used for the production of carbon-bonded refractory ceramic products, for example coking binders in the form of synthetic resin or pitch.

The raw materials present in addition to the fused raw material according to the invention in the batch for the production of the plate according to the invention may be one or more raw materials based on alumina, zirconia or zircon mullite. As further raw materials, one or more carbon carriers as well as antioxidants and elasticizers may be present in the batch.

The mixed raw materials of the batch for the production of the plate according to the invention can first be formed into a green body by pressing using the processes known from the state of the art. This green body already represents an embodiment of the plate according to the invention, namely an embodiment in the form of an unfired plate. The green body or the unfired plate according to the invention can then be fired, especially under reducing conditions. During the firing, the carbon of the batch or the green body forms a carbon bond, so that the fired green body is subsequently present as a refractory product in the form of a fired plate according to the invention, namely in the form of a fired, carbon-bonded refractory plate.

From the unfired plate according to the invention, a fired plate according to the invention with excellent refractory properties can be produced. Thus, the fired plate according to the invention may have the following properties.

In particular, the fired plate (not impregnated with pitch) according to the invention may have at least one of the following physical values:

Thermal expansion coefficient <9.0*10−6 K⁻¹;

Dynamic modulus of elasticity (Young's modulus) at 1,400° C. in reducing atmosphere (sound travel time measurement) <65 GPa;

Cold bending strength >15 MPa;

Hot bending strength at 1,400° C. in reducing atmosphere >13 MPa;

Work at break Gf at 1,400° C. in reducing atmosphere >250, in particular >300 J/m²;

Nominal notched tensile strength σNT at 1,400° C. in reducing atmosphere >5 MPa;

Thermal shock parameter R according to Kingery at 1,400° C. >10 K;

Thermal shock parameter Rₛₜ according to Hasselmann at 1,400° C. >5.5 K*m^{1/2}.

Preferably, the plate according to the invention exhibits all of the above physical values.

Furthermore, in accordance with the invention, it was found surprisingly that the hot bending strength of the fired plate according to the invention can be increased quite considerably by soaking the fired plate in pitch, as known from the state of the art, and this regularly disproportionately compared to the increase in hot bending strength of generic plates according to the state of the art by pitch soaking. For example, a fired plate according to the invention, after it has been soaked in pitch in the fired state, can exhibit a hot bending strength at 1,400° C. in a reducing atmosphere of more than 20 MPa, in particular also more than 30 MPa.

The thermal expansion is determined according to DIN 51045-4:2007-01.

The dynamic modulus of elasticity is determined according to DIN 51942:2002.

The cold bending strength is determined according to DIN EN 993-6:1995-04.

The hot bending strength is determined according to DIN EN 993-7:1998.

The work at break and the nominal notched tensile strength are determined according to the specifications in the following literature, whereby the measurements were carried out at 1,400° C.: Harmuth H., Manhart Ch., Auer Th., Gruber D.: “Fracture Mechanical Characterisation of Refractories and Application for Assessment and Simulation of the Thermal Shock Behaviour”, CFI Ceramic Forum International, Vol. 84, No. 9, pp. E80 -E86 (2007).

The thermal shock parameter R according to Kingery was determined according to the information given in the following literature reference: “Factors Affecting Thermal Stress Resistance of Ceramics Materials”, J. Am. Ceram. Soc. 1955; 38 (1): 3-15, after which the thermal shock parameter R according to R=Nominal notched tensile strength/(coefficient of thermal expansion*modulus of elasticity).

The thermal shock parameter Rₛₜ according to Hasselmann was determined according to the specifications in the following literature: Hasselmann DPH: “Unified theory of thermal shock fracture intiation and crack propagation in brittle ceramics”, J. Am. Ceram. Soc. 1969; 52 (11): 600-04, after which the thermal shock parameter Rₛₜ is calculated according to Rₛₜ=root of [Gf/(2* coefficient of thermal expansion²* modulus of elasticity)].

Furthermore, the plate according to the invention is characterized by excellent corrosion resistance, which can be proven by an ITO test, for example (see below).

A subject of the invention is also the use of the fused raw material according to the invention as raw material in a plate.

A subject of the invention is also a melting vessel for holding liquid steel, the melting vessel having at least one plate according to the invention for controlling a flow rate of liquid steel from the melting vessel.

The melting vessel may in particular be a melting vessel in a continuous casting plant for casting steel, in particular a ladle or a tundish.

Further features of the invention result from the claims and from the following description of an example of an embodiment of the invention.

All features of the invention may, individually or in combination, be combined with each other as desired.

An exemplary embodiment of the invention is explained in more detail below.

The subject of the exemplary embodiment of the invention is a refractory plate in the form of a carbon-bonded refractory slide gate plate based on the raw materials alumina, zircon mullite and the fused raw material according to the invention.

For the production of the slide gate plate, a batch was provided, which contained the raw materials in the proportions shown in Table 1 below, each in relation to the total mass of the batch:

TABLE 1

| Raw material | Mass fraction [% by mass] |
|---|---|
| Fused raw material >1.0 to 3.0 mm | 21.1 |
| Fused raw material >0.5 to 1.0 mm | 10.6 |
| Fused raw material >0.0 to 0.5 mm | 17.3 |
| Alumina <125 μm | 21.8 |
| Zircon mullite <3.0 mm | 16.1 |
| Graphite | 3.0 |
| Antioxidants (silicon and SiC) | 5.5 |
| Hexamethylentetramine | 0.5 |
| Synthetic resin (Novolak) | 4.1 |

The fused raw material for the batch according to Table 1 was produced as follows.

First of all, a batch was provided, consisting of 89% by mass of calcined alumina, 8% by mass of fireclay and 3% by mass of graphite. This batch was melted to a melt in an electric arc furnace. The melt was then cooled down to room temperature and the melt solidified. The solidified melt was available in the form of a fused raw material according to the invention. In order to provide this fused raw material in the grain size according to the batch in Table 1, the fused raw material was comminuted and made available by sieving in the grain size according to Table 1.

The fused raw material had the following elements in the proportions according to Table 2 below, each in relation to the total mass of the fused raw material:

TABLE 2

| Element | Mass fraction [% by mass] |
|---|---|
| Aluminum | 51.70 |
| Oxygen | 46.70 |
| Carbon | 0.79 |
| Silicon | 0.69 |
| Nitrogen | 0.12 |
| Further | <0.10 |

The mineralogical main phase of the fused raw material was corundum (Al₂O₃) in a proportion of more than 95.4% by mass and in addition the phases Al₂₈C₆N₆O₂₁ in a proportion of 2.0% by mass and SiC in a proportion of 1.6% by mass. Other phases, including metallic silicon and traces of Al₄O₄C, were present in a total mass of 1.0% by mass. The figures in % by mass are in each case based on the total mass of the fused raw material.

In the batch according to Table 1, the raw materials alumina and zircon mullite were present as further main raw materials in addition to the fused raw material according to the invention.

Graphite was present as the carbon component.

Metallic silicon and silicon carbide were present as antioxidants.

Synthetic resin (together with hexamethylenetetramine as hardener) was present in the batch as a coking binder.

The components of the batch according to Table 1 were intimately mixed in a mixer and then pressed in a press to form the green body of a slide gate plate.

This slide gate plate was an embodiment of an unfired plate according to the invention in the form of a slide ate plate.

The green body was then first tempered at 250° C., whereby the volatile components of the binder evaporated.

The tempered green body was then heated to 1,200° C. in a reducing atmosphere and kept at this temperature for a period of three hours in a reducing atmosphere. During this firing process, the carbon components of the graphite and the binder formed a carbon bond.

After cooling, an embodiment of a plate according to the invention was provided in the form of a fired, carbon-bonded refractory slide gate plate.

In order to be able to compare the properties of this exemplary embodiment of a fired slide gate plate according to the invention with the properties of a generic slide gate plate according to the state of the art, a generic fired slide gate plate was produced according to the state of the art. This state of the art slide gate plate was manufactured according to the above exemplary embodiment, but with the only difference that instead of the fused raw material according to the invention, fused alumina according to the state of the art was used.

The physical properties were then determined on both slide gate plates. Table 3 below shows the physical properties determined, whereby the slide gate plate according to the exemplary embodiment is designated “E” and the slide gate plate according to the state of the art is designated “S”.

TABLE 3

| Physical value | S | E |
|---|---|---|
| Thermal expansion coefficient [K⁻¹] | 8.6 * 10⁻⁶ | 8.8 * 10⁻⁶ |
| Modulus of elasticity [GPa] | 58.4 | 62.5 |
| Cold bending strength [MPa] | 13 | 16.1 |
| Hot bending strength [MPa] | 11.1 | 15.1 |
| Work at break [J/m²] | 249 | 346 |
| Notched tensile strength [MPa] | 3.6 | 6.8 |
| Thermal shock parameter R | 7.2 | 12.5 |
| according to Kingery [K] | | |
| Thermal shock parameter Rₛₜ | 5.4 | 6.0 |
| according to Hasselmann [K*m^{1/2}] | | |

The modulus of elasticity is the dynamic modulus of elasticity measured by sound travel time measurement at 1,400° C. under reducing conditions.

The hot bending strength was measured at 1,400° C. under reducing conditions.

The work at break is the work at break G_{f}, which was also measured at 1,400° C. under reducing conditions.

The nominal notched tensile strength is the nominal notched tensile strength σNT at 1,400° C. under reducing conditions.

The thermal shock parameters R according to Kingery and Rst according to Hasselmann were each calculated on the basis of parameters measured at 1,400° C. under reducing conditions.

All values were measured and determined according to the above-mentioned standards and literature.

As can be seen from Table 3, the slide gate plate according to the invention proved to be superior to the standard slide gate plate according to the state of the art with regard to practically all of these values (with the exception of the modulus of elasticity).

Furthermore, a slide gate plate according to the invention and a state of the art slide gate plate were manufactured according to the above example, but with the difference that both slide plates were soaked with pitch after firing. According to this, the embodiment of the fired slide gate plate according to the invention had a hot bending strength of 34.2 MPa and the fired slide gate plate according to the state of the art had a hot bending strength of 14.4 MPa.

To determine the corrosion resistance of the slide gate plates (not soaked with pitch), a so-called ITO test was also carried out. In this test, stone segments were cut from the slide gate plate E according to the inventions as well as from the slide gate plate S according to the state of the art and used as part of a furnace lining, on which a corrosion test according to the so-called “induction crucible furnace test” (ITO test) was carried out as follows: First of all, a furnace was constructed whose refractory lining was made of stone segments on the wall side. In the later slag area, the lining was partially formed from the aforementioned brick segments of slide gate plates E and S. The refractory lining enclosed a circular-cylindrical furnace chamber into which a matching circular-cylindrical metal insert (60 kg steel) was placed. The metal insert was heated to 1,600° C. and melted by coils which were guided in a ring around the outside of the lining. A slag powder (3 kg) with the chemical composition shown in Table 4 below (proportions indicated in relation to the total mass of the slag powder) was added to the molten steel, which melted and formed a slag area with a corrosive slag. The slag reacted in the slag area with the stone segments from the slide gate plates E and S and thereby corrosively damaged them. The stone segments were corroded by the slag for a total of about five hours, with the slag being renewed regularly. The lining was then removed and the degree of corrosion was tested on the stone segments, namely the wear surface.

TABLE 4

| Component of the slag | Mass fraction [% by mass] |
|---|---|
| Al₂O₃ | 10.0 |
| SiO₂ | 10.1 |
| Fe₃O₄ | 26.1 |
| CaO | 37.6 |
| MnO | 11.1 |
| MgO | 4.2 |
| F | 0.5 |
| S | 0.4 |

For the determination of the wear, the wear surface of the stone segments from the slide gate plate S was normalized to 100% according to the state of the art and set in relation to the corresponding value for the stone segments from the slide gate plate E according to the invention. The wear surface is the maximum cross-sectional area of the corroded areas of the stone segments. According to this, the wear of the stone segments of the slide gate plate E according to the invention amounted to an average of only 82% of the wear surface of the stone segments from the slide gate plate S according to the state of the art.

1. A refractory plate for a slide gate valve for controlling a flow rate of liquid steel, comprising a fused raw material, wherein the fused raw material comprises the following elements each in a proportion in the range of the following mass fractions:
aluminum: 46 to 55% by mass;
oxygen: 42 to 49% by mass;
carbon: 0.1 to 3% by mass;
silicon: 0.1 to 4% by mass.

2. Plate according to claim 1, wherein the fused raw material comprises the phase Al₂₈C₆N₆O₂₁.

3. Plate according to claim 1, wherein the fused raw material comprises the phase Al₂₈C₆N₆O₂₁ in a proportion in the range from 0.05 to 10% by mass.

4. Plate according to claim 1, wherein the fused raw material comprises the element nitrogen.

5. Plate according to claim 1, wherein the fused raw material comprises the element nitrogen in a proportion of at most 0.3% by mass.

6. Plate according to claim 1, wherein the fused raw material comprises the elements aluminum, oxygen, carbon, silicon and nitrogen in a total proportion of at least 98% by mass.

7. Plate according to claim 1, wherein the fused raw material comprises metallic silicon.

8. Plate according to claim 1, wherein the fused raw material comprises the phase SiC.

9. Plate according to claim 1, wherein the fused raw material comprises the phase corundum.

10. Plate according to claim 1, which comprises the fused raw material in a proportion in the range from 3 to 70% by mass.

11. Plate according to claim 1 in the form of either an unfired or fired carbon bonded product.

12. Plate according to claim 1, which has at least one of the following physical values:
Thermal expansion coefficient <9.0*10−6 K⁻¹;
Dynamic modulus of elasticity (Young's modulus) at 1,400° C. in reducing atmosphere (sound travel time measurement) <65 GPa;
Cold bending strength >15 MPa;
Hot bending strength at 1,400° C. in reducing atmosphere >13 MPa;
Work at break Gf at 1,400° C. in reducing atmosphere >250, in particular >300 J/m²;
Nominal notched tensile strength σNT at 1,400° C. in reducing atmosphere >5 MPa;
Thermal shock parameter R according to Kingery at 1,400° C. >10 K;
Thermal shock parameter Rₛₜ according to Hasselmann at 1,400° C. >5.5 K*m^{1/2}.

13. A method comprising:
using a fused raw material as raw material in a plate for a slide gate valve, wherein the fused raw material comprises the following elements each in a proportion in the range of the following mass fractions:
aluminum: 46 to 55% by mass;
oxygen: 42 to 49% by mass;
carbon: 0.1 to 3% by mass;
silicon: 0.1 to 4% by mass.

14. Melting vessel for receiving liquid steel, wherein the melting vessel comprises at least one plate for controlling a flow rate of liquid steel from the melting vessel, wherein the at least one plate comprises a fused raw material, wherein the fused raw material comprises the following elements each in a proportion in the range of the following mass fractions:
aluminum: 46 to 55% by mass;
oxygen: 42 to 49% by mass;
carbon: 0.1 to 3% by mass;
silicon: 0.1 to 4% by mass.

15. Melting vessel according to claim 14 in the form of a ladle or tundish in a continuous casting plant for casting steel.
